(19) United States
(12) Patent Application Publication
(10) Pub. No.: US 2026/0032668 A1
(43) Pub. Date: Jan. 29, 2026

(54) GROUP COMMON RESOURCE FOR SCHEDULING REQUESTS

(71) Applicant: QUALCOMM INCORPORATED, San Diego, CA (US)

(72) Inventors: Zhichao ZHOU, Beijing (CN); Diana MAAMARI, San Diego, CA (US); Mickael MONDET, Louannec (FR); Ahmed ELSHAFIE, San Diego, CA (US); Chih-Ping LI, San Diego, CA (US)

(21) Appl. No.: 19/138,495

(22) PCT Filed: Mar. 1, 2023
(86) PCT No.: PCT/CN2023/078933

§ 371 Date: Jun. 12, 2025

(51) Int. Cl. H04W 72/121; H04W 72/231; H04W 72/232

(52) U.S. Cl. CPC H04W 72/121; H04W 72/231; H04W 72/232

(57) ABSTRACT

Various aspects of the present disclosure generally relate to wireless communication. In some aspects, a user equipment (UE) may receive a grant associated with a group common scheduling request (SR) resource. The UE may transmit an SR based at least in part on the UE belonging to a group associated with the group common SR resource. Numerous other aspects are described.

### FIELD OF THE DISCLOSURE

Aspects of the present disclosure generally relate to wireless communication and to techniques and apparatuses for using a group common resource for scheduling requests.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a grant associated with a group common scheduling request (SR) resource. The method may include transmitting an SR based at least in part on the UE belonging to a group associated with the group common SR resource.

Some aspects described herein relate to a method of wireless communication performed by a UE. The method may include receiving reservation information, associated with scheduling requests (SRs), from other UEs. The method may include selectively transmitting an SR based at least in part on a priority of each UE indicated in the reservation information.

Some aspects described herein relate to a method of wireless communication performed by a UE. The method may include receiving a configuration for a default order of UEs for SRs. The method may include selectively transmitting an SR based at least in part on a location of the UE within the default order.

Some aspects described herein relate to a method of wireless communication performed by a UE. The method may include sensing for other UEs using a multiplexing resource for SRs. The method may include selectively transmitting an SR based at least in part on a result of the sensing.

Some aspects described herein relate to a method of wireless communication performed by a network entity. The method may include transmitting a grant associated with a group common SR resource. The method may include receiving an SR based at least in part on a UE belonging to a group associated with the group common SR resource.

Some aspects described herein relate to a method of wireless communication performed by a network entity. The method may include transmitting a configuration for a default order of UEs for SRs. The method may include receiving an SR based at least in part on a location of a UE within the default order.

Some aspects described herein relate to a UE for wireless communication. The UE may include a memory and one or more processors coupled to the memory. The one or more processors may be configured to receive a grant associated with a group common SR resource. The one or more processors may be configured to transmit an SR based at least in part on the UE belonging to a group associated with the group common SR resource.

Some aspects described herein relate to a UE for wireless communication. The UE may include a memory and one or more processors coupled to the memory. The one or more processors may be configured to receive reservation information, associated with SRs, from other UEs. The one or more processors may be configured to selectively transmit an SR based at least in part on a priority of each UE indicated in the reservation information.

Some aspects described herein relate to a UE for wireless communication. The UE may include a memory and one or more processors coupled to the memory. The one or more processors may be configured to receive a configuration for a default order of UEs for SRs. The one or more processors may be configured to selectively transmit an SR based at least in part on a location of the UE within the default order.

Some aspects described herein relate to a UE for wireless communication. The UE may include a memory and one or more processors coupled to the memory. The one or more processors may be configured to sense for other UEs using a multiplexing resource for SRs. The one or more processors may be configured to selectively transmit an SR based at least in part on a result of the sensing.

Some aspects described herein relate to network entity for wireless communication. The network entity may include a memory and one or more processors coupled to the memory. The one or more processors may be configured to transmit a grant associated with a group common SR resource. The one or more processors may be configured to receive an SR based at least in part on a UE belonging to a group associated with the group common SR resource.

Some aspects described herein relate to a network entity for wireless communication. The network entity may include a memory and one or more processors coupled to the memory. The one or more processors may be configured to transmit a configuration for a default order of UEs for SRs. The one or more processors may be configured to receive an SR based at least in part on a location of a UE within the default order.

Some aspects described herein relate to a non-transitory computer-readable medium that stores a set of instructions for wireless communication by a UE. The set of instructions, when executed by one or more processors of the UE, may cause the UE to receive a grant associated with a group common SR resource. The set of instructions, when executed by one or more processors of the UE, may cause the UE to transmit an SR based at least in part on the UE belonging to a group associated with the group common SR resource.

Some aspects described herein relate to a non-transitory computer-readable medium that stores a set of instructions for wireless communication by a UE. The set of instructions, when executed by one or more processors of the UE, may cause the UE to receive reservation information, associated with SRs, from other UEs. The set of instructions, when executed by one or more processors of the UE, may cause the UE to selectively transmit an SR based at least in part on a priority of each UE indicated in the reservation information.

Some aspects described herein relate to a non-transitory computer-readable medium that stores a set of instructions for wireless communication by a UE. The set of instructions, when executed by one or more processors of the UE, may cause the UE to receive a configuration for a default order of UEs for SRs. The set of instructions, when executed by one or more processors of the UE, may cause the UE to selectively transmit an SR based at least in part on a location of the UE within the default order.

Some aspects described herein relate to a non-transitory computer-readable medium that stores a set of instructions for wireless communication by a UE. The set of instructions, when executed by one or more processors of the UE, may cause the UE to sense for other UEs using a multiplexing resource for SRs. The set of instructions, when executed by one or more processors of the UE, may cause the UE to selectively transmit an SR based at least in part on a result of the sensing.

Some aspects described herein relate to a non-transitory computer-readable medium that stores a set of instructions for wireless communication by a network entity. The set of instructions, when executed by one or more processors of the network entity, may cause the network entity to transmit a grant associated with a group common SR resource. The set of instructions, when executed by one or more processors of the network entity, may cause the network entity to receive an SR based at least in part on a UE belonging to a group associated with the group common SR resource.

Some aspects described herein relate to a non-transitory computer-readable medium that stores a set of instructions for wireless communication by a network entity. The set of instructions, when executed by one or more processors of the network entity, may cause the network entity to transmit a configuration for a default order of UEs for SRs. The set of instructions, when executed by one or more processors of the network entity, may cause the network entity to receive an SR based at least in part on a location of a UE within the default order.

Some aspects described herein relate to an apparatus for wireless communication. The apparatus may include means for receiving a grant associated with a group common SR resource. The apparatus may include means for transmitting an SR based at least in part on the apparatus belonging to a group associated with the group common SR resource.

Some aspects described herein relate to an apparatus for wireless communication. The apparatus may include means for receiving reservation information, associated with SRs, from other apparatuses. The apparatus may include means for selectively transmitting an SR based at least in part on a priority of each apparatus indicated in the reservation information.

Some aspects described herein relate to an apparatus for wireless communication. The apparatus may include means for receiving a configuration for a default order of apparatuses for SRs. The apparatus may include means for selectively transmitting an SR based at least in part on a location of the apparatus within the default order.

Some aspects described herein relate to an apparatus for wireless communication. The apparatus may include means for sensing for other apparatuses using a multiplexing resource for SRs. The apparatus may include means for selectively transmitting an SR based at least in part on a result of the sensing.

Some aspects described herein relate to an apparatus for wireless communication. The apparatus may include means for transmitting a grant associated with a group common SR resource. The apparatus may include means for receiving an SR based at least in part on another apparatus belonging to a group associated with the group common SR resource.

Some aspects described herein relate to an apparatus for wireless communication. The apparatus may include means for transmitting a configuration for a default order of apparatuses for SRs. The apparatus may include means for selectively transmitting an SR based at least in part on a location of another apparatus within the default order.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of scheduling request collisions, in accordance with the present disclosure.

FIG. 5 is a diagram illustrating an example associated with using a group common resource for scheduling requests (SRs), in accordance with the present disclosure.

FIG. 6 is a diagram illustrating an example associated with using a group common resource for SRs, in accordance with the present disclosure.

FIG. 7 is a diagram illustrating an example associated with a default order for using a group common resource for SRs, in accordance with the present disclosure.

FIG. 8 is a diagram illustrating an example associated with using a group common resource for SRs, in accordance with the present disclosure.

FIG. 9 is a diagram illustrating an example process performed, for example, by a UE, in accordance with the present disclosure.

FIG. 10 is a diagram illustrating an example process performed, for example, by a UE, in accordance with the present disclosure.

FIG. 11 is a diagram illustrating an example process performed, for example, by a UE, in accordance with the present disclosure.

FIG. 12 is a diagram illustrating an example process performed, for example, by a UE, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Extended reality (XR) traffic is latency sensitive and requires high reliability. A dynamic grant-based uplink transmission requires a scheduling request (SR), which requests an uplink resource for transmission. When the quantity of XR user equipments (UEs) is large and each UE is configured with one specific SR, latency increases due to the wait for a transmission SR on a resource. Contention-based SR expects for multiple UEs to share the same configured resource for SR transmissions using multiplexing, which can save resources and solve bottleneck issues for uplink capacity. While latency can be lowered with the contention-based SR transmission, when an SR collision occurs, the UEs have to back off for a time before retransmitting the SR. This is time consuming and can be fatal to latency-sensitive uplink XR traffic. If SR collision occurs, signaling resources are wasted, since no useful SR information is transmitted successfully on the configured resource.

According to various aspects described herein, a UE may use a group common SR resource for transmitting an SR. There may be multiple group common uplink resources for multiple groups of UEs to reduce the probability of collision. Having smaller quantities of UEs share the same resource for SR transmission reduces the chance of the resource being unavailable for a long period of time. As a result, latency is reduced and signaling resources are conserved.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

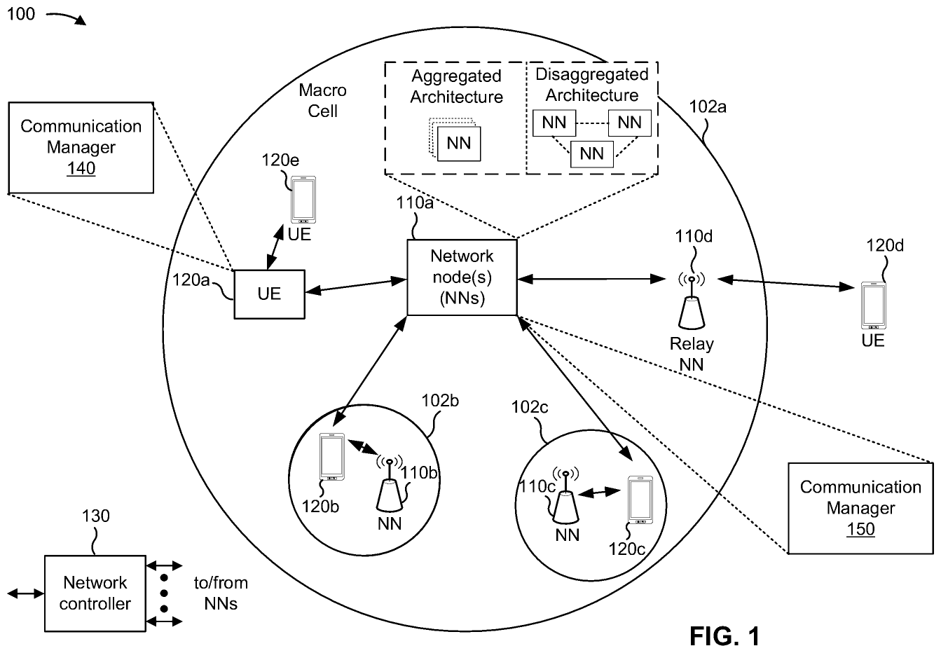

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UF 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D)) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive a grant associated with a group common SR resource. The communication manager 140 may transmit an SR based at least in part on the UE belonging to a group associated with the group common SR resource.

In some aspects, the communication manager 140 may receive reservation information, associated with SRs, from other UEs. The communication manager 140 may selectively transmit an SR based at least in part on a priority of each UE indicated in the reservation information.

In some aspects, the communication manager 140 may receive a configuration for a default order of UEs for SRs. The communication manager 140 may selectively transmit an SR based at least in part on a location of the UE within the default order.

In some aspects, the communication manager 140 may sense for other UEs using a multiplexing resource for SRs. The communication manager 140 may selectively transmit an SR based at least in part on a result of the sensing. Additionally, or alternatively, the communication manager 140 may perform one or more other operations described herein.

In some aspects, a network entity (e.g., a network node 110) may include a communication manager 150. As described in more detail elsewhere herein, the communication manager 150 may transmit a grant associated with a group common SR resource. The communication manager 150 may receive an SR based at least in part on a UE belonging to a group associated with the group common SR resource.

In some aspects, the communication manager 150 may transmit a configuration for a default order of UEs for SRs. The communication manager 150 may receive an SR based at least in part on a location of a UE within the default order.

As indicated above, FIG. 1 is provided as an example. Other examples may differ from what is described with regard to FIG. 1.

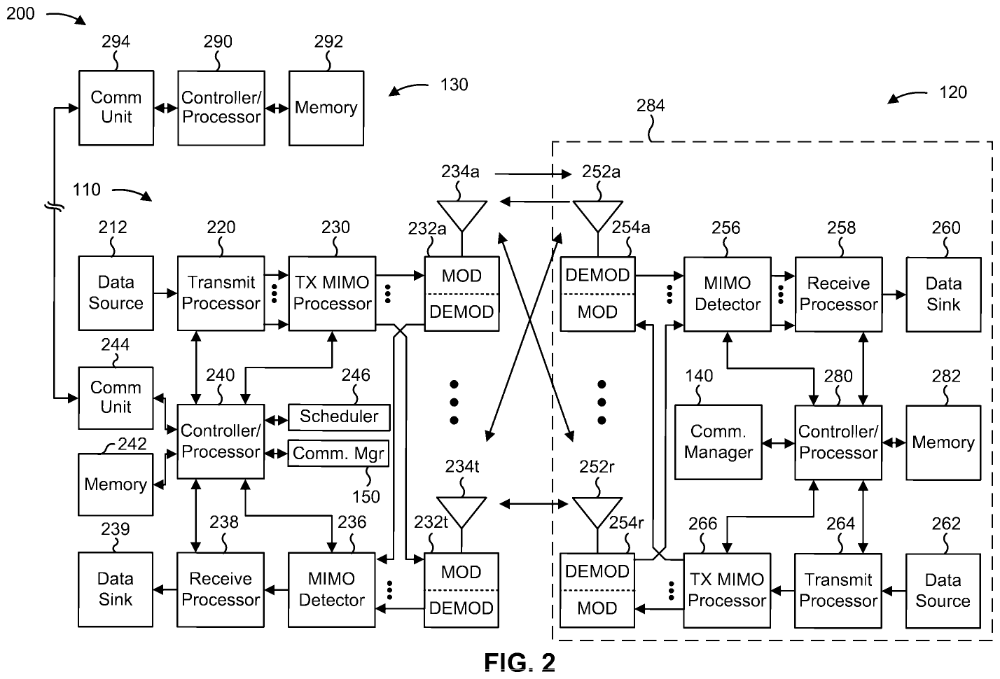

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

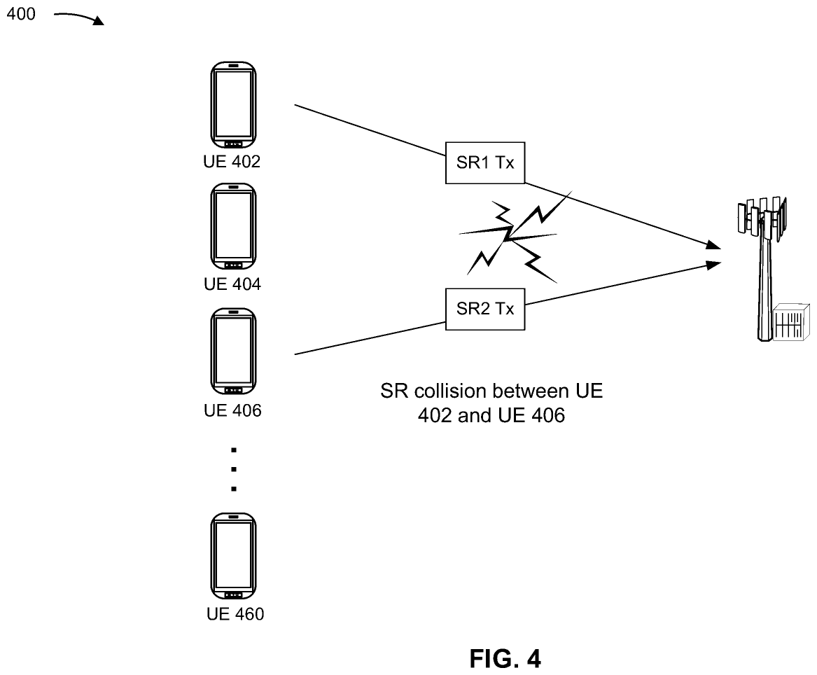

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-14).

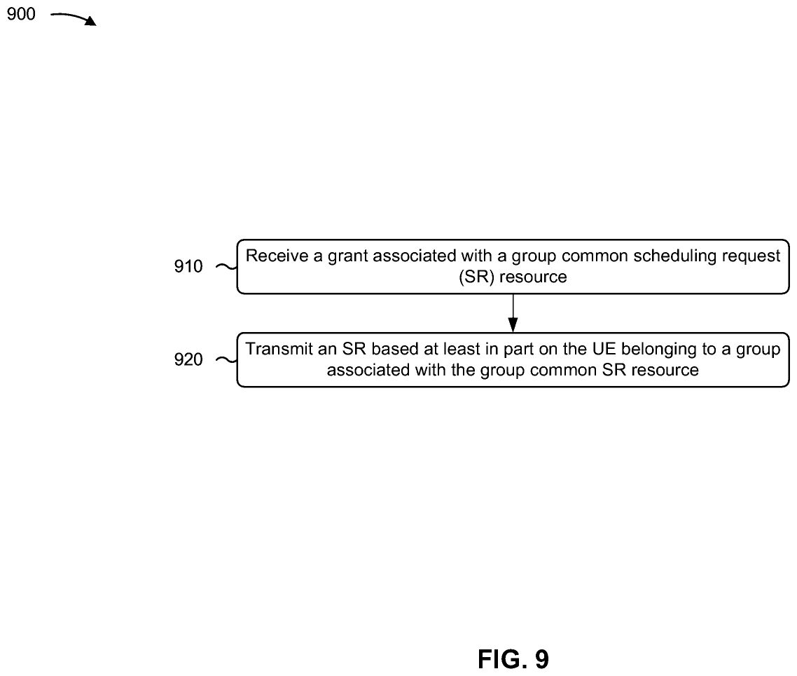

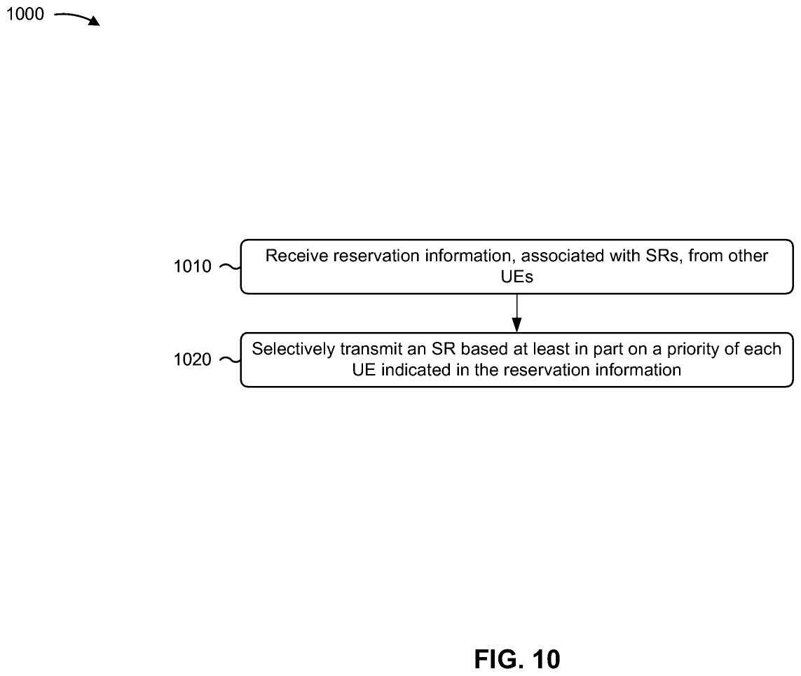

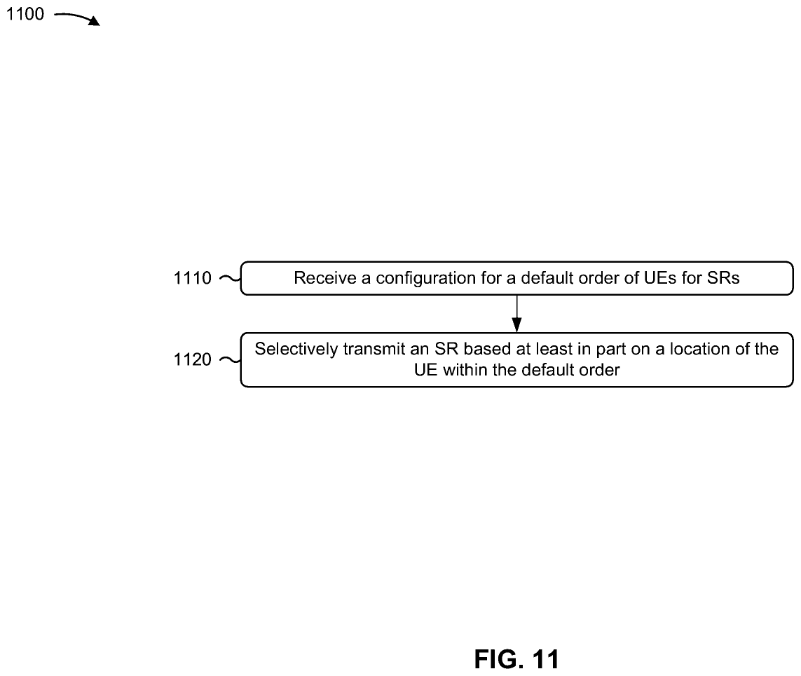

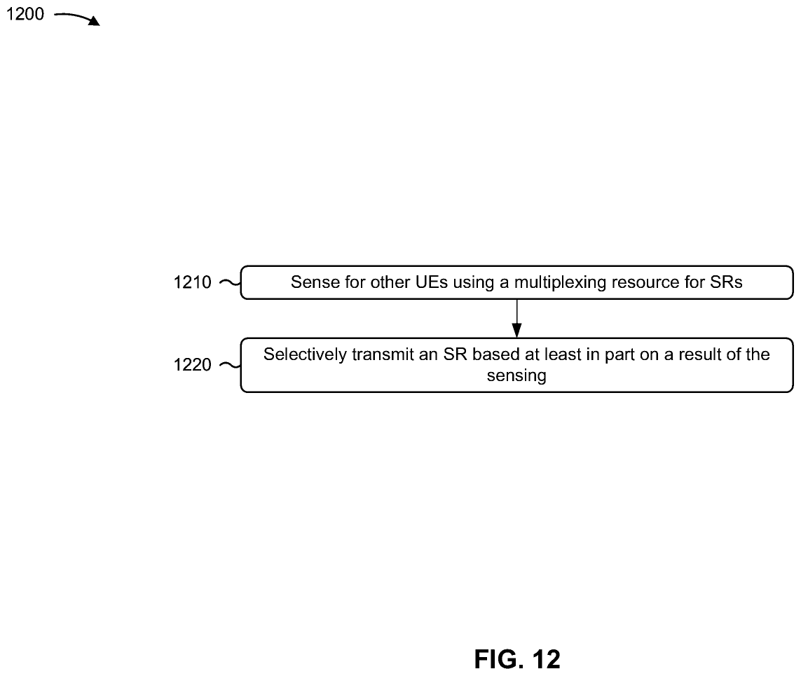

The controller/processor 240 of the network node 110, the controller/processor 280 of the UE 120, and/or any other component(s) of FIG. 2 may perform one or more techniques associated with using a group common resource for SRs, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a UE (e.g., a UF 120) includes means for receiving a grant associated with a group common SR resource; and/or means for transmitting an SR based at least in part on the UE belonging to a group associated with the group common SR resource. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving reservation information, associated with SRs, from other UEs; and/or means for selectively transmitting an SR based at least in part on a priority of each UE indicated in the reservation information.

In some aspects, the UE includes means for receiving a configuration for a default order of UEs for SRs; and/or means for selectively transmitting an SR based at least in part on a location of the UE within the default order.

In some aspects, the UF includes means for sensing for other UEs using a multiplexing resource for SRs; and/or means for selectively transmitting an SR based at least in part on a result of the sensing.

In some aspects, a network entity (e.g., a network node 110) includes means for transmitting a grant associated with a group common SR resource; and/or means for receiving an SR based at least in part on a UE belonging to a group associated with the group common SR resource. The means for the network entity to perform operations described herein may include, for example, one or more of communication manager 150, antenna 234, modem 232, MIMO detector 236, receive processor 238, transmit processor 220, TX MIMO processor 230, controller/processor 240, or memory 242.

In some aspects, the network entity includes means for transmitting a configuration for a default order of UEs for SRs; and/or means for receiving an SR based at least in part on a location of a UE within the default order.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

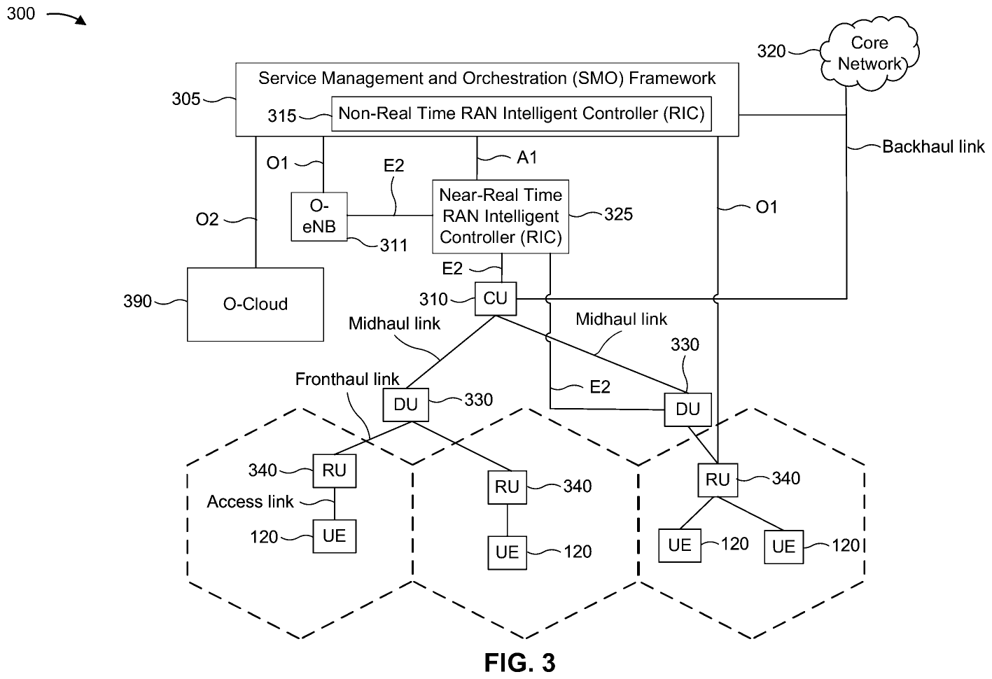

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UF 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of scheduling request collisions, in accordance with the present disclosure.

XR traffic is latency sensitive with high reliability, and dynamic grant (DG)-based uplink transmissions require SRs. When the quantity of XR UEs is large and each UE is configured with one specific SR, latency increases due to the wait for a transmission SR on an independent resource. Physical uplink control channel (PUCCH) resources can become a bottleneck to uplink capacity.

The impact of SR collisions when using a legacy SR configuration becomes more significant for XR or configured grant (CG) communications than for traditional enhanced mobile broadband (eMBB) or ultra-reliable low latency communications (URLLC) traffic. Contention-based SR may be more suitable for XR/CG traffic than for traditional eMBB/URLLC traffic. However, collisions in contention-based SR becomes more impactful for XR/CG traffic. Example 400 shows multiple UEs, such as UE 402, UE 404, UE 406, up to UE 460. An SR (SR1 Tx) from UE 402 may collide with an SR (SR3 Tx) from UE 406. The amount of successful XR/CG UEs reduces as the quality of service (QoS) increases. With more UEs, the XR/CG experience becomes degraded because the SR collisions lead to a greater latency.

Contention-based SR expects for multiple UEs to share the same configured resource for SR transmissions using multiplexing, which can save resources and solve the PUCCH bottleneck issue for uplink capacity. Multiplexing SRs enables UEs to be more efficient than legacy mechanisms, in which the UE has to wait for the configured specific resource for its SR transmission if an uplink traffic load arrives earlier than the configured PUCCH resource for the SR. Latency can be lowered with the contention-based SR transmission, but when an SR collision occurs, the UEs have to back off for a time before retransmitting the SR. This is time consuming and can be fatal to latency-sensitive uplink XR traffic. If SR collision occurs, signaling resources are wasted since no useful SR information is transmitted successfully on the configured resource.

As indicated above, FIG. 4 is provided as an example. Other examples may differ from what is described with regard to FIG. 4.

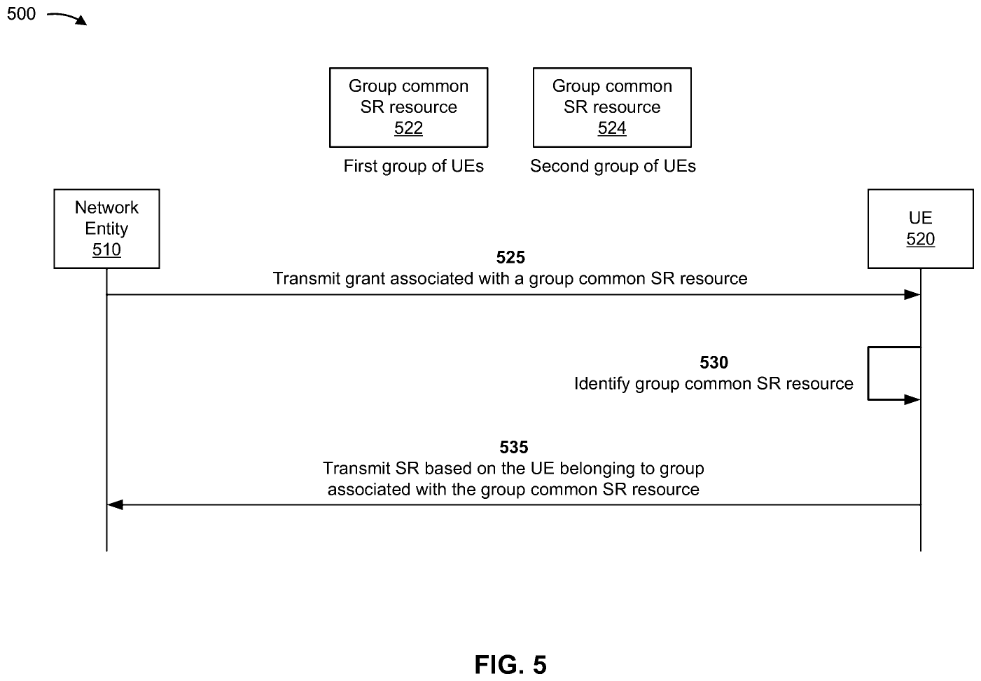

FIG. 5 is a diagram illustrating an example 500 associated with using a group common resource for SRs, in accordance with the present disclosure. As shown in FIG. 5, a network entity 510 (e.g., network node 110) and a UE 520 (e.g., UE 120) may communicate with one another via a wireless network (e.g., wireless network 100).

According to various aspects described herein, the UE 520 may use a group common SR resource for transmitting an SR. There may be multiple group common PUCCH resources for multiple groups (or subgroups) of XR/CG UEs to reduce the probability of collision. Having smaller quantities of UEs share the same resource for SR transmission reduces the chance of a resource being unavailable for a long period of time. This reduces latency and conserves signaling resources. The capacity is increased and the user has a smoother XR experience.

The network entity 510 may use higher layer signaling (e.g., RRC messages) to assign UEs to the multiple groups, and the network entity 510 may assign a specific PUCCH resource to each group to support SR transmission. An SR configuration (e.g., SchedulingRequestResourceConfig of RRC) may be enhanced to include multiple scheduling request identifiers (IDs). For example, the resource configured in SchedulingRequestResourceConfig may be multiplexed by multiple UEs or multiple SRs corresponding to multiple logical channels in one UE.

In an example, the UE 520 may belong to a first group of UEs that share a first group common SR resource 522. A second group of UEs may share a second group common SR resource 524. The first group common SR resource 522 and the second group common SR resource 524 may or may not overlap. A contention-based SR procedure for the UE 520 may be limited to the first group of UEs and exclude the second group of UEs. The UE 520 in the first group may randomly select a resource to conduct SR transmission.

As shown by reference number 525, the network entity 510 may transmit a grant that is associated with a group common SR resource (e.g., the first group common SR resource 522). The grant may be directed to the first group of UEs and may be identifiable by the first group of UEs. As shown by reference number 530, the UE 520 may identify the first group common SR resource 522. In some aspects, the UE 520 may distinguish the first group common SR resource 522 from the second group common SR resource 524 by a cell-specific radio network temporary identifier (C-RNTI). The first group common SR resource 522 may be scrambled with a specific C-RNTI.

In some aspects, the network entity 510 may activate or deactivate a specific group common SR resource using Layer 1 (L1) or Layer 2 (L2) signaling (e.g., group common downlink control information (DCI), a medium access control control element (MAC CE)). The network entity 510 may activate or deactivate a specific group common SR resource using a wake-up signal (WUS) that is enhanced to identify a group common SR resource. For example, the WUS may be scrambled with an identifier that is associated with the group. As shown by reference number 535, the UE 520 may transmit an SR based at least in part on the UE 520 belonging to the group associated with the group common SR resource that was identified. If the UE 520 belongs to the group, the UE 520 transmits the SR. If the UE 520 does not belong to the group, the UE 520 refrains from transmitting the SR.

In some aspects, a group common C-RNTI may be enhanced in order to respond to a group common SR. The group common C-RNTI may include a UE-specific C-RNTI in a MAC CE for the network entity 510 to detect which UE transmitted the sequent physical uplink shared channel (PUSCH) communication. In response to a dedicated SR (legacy SR), the network entity 510 may transmit an uplink grant that is scrambled with the C-RNTI of the UE 520 that transmitted the SR. In some aspects, the C-RNTI may be enhanced to become a group common C-RNTI in response to a group common SR. The network entity 510 may use the group common C-RNTI to configure the uplink grant to the UE in a certain group or subgroup. Moreover, in order to assist the network entity 510 with identifying which UE transmitted a PUSCH communication on the configured uplink grant, the UE-specific C-RNTI may be inserted into a MAC CE. Once the network entity 510 detects the UE-specific C-RNTI, the network entity 510 may identify which XR/CG UE transmitted the PUSCH communication.

In some aspects, the group common-based resource for multiplexing by multiple XR/CG UEs to transmit SRs may be configured by high layer signaling and activated or deactivated by L1/L2 signaling (e.g., group common DCI, group common MAC CE) or by an enhanced WUS signaling (e.g., specific-function WUS signaling). Once the specific group common resource is activated, UEs belonging to the specific group can use a preconfigured resource to transmit SRs. In some aspects, contention among UEs may exist only within each group. The smaller quantity of UEs in each group will lower the collision probability as compared to a greater quantity of UEs that contend for the shared SR resource.

As indicated above, FIG. 5 is provided as an example. Other examples may differ from what is described with respect to FIG. 5.

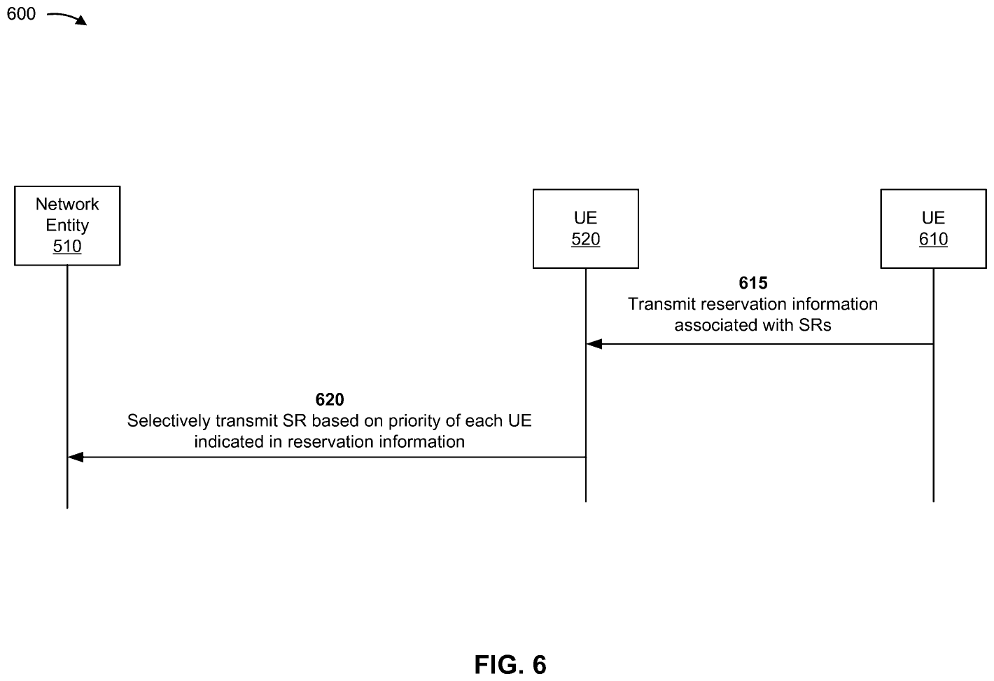

FIG. 6 is a diagram illustrating an example 600 associated with using a group common resource for SRs, in accordance with the present disclosure. As shown in FIG. 6, UE 520 and another UF 610 (e.g., UE 120) may communicate with one another via the wireless network.

In contention-based SR mechanism, multiple UEs multiplex the same PUCCH resource for SR transmission. The collision probability can be high when a UE randomly selects a resource to transmit an SR and when the quantity of UEs is large. In some aspects, the UE 520 may enhance the random selection mechanism to be more orderly when UEs are to transmit SRs. The UE 520 may preempt the SR resource according to its priority.

In some aspects, the UE 520 may preempt an SR resource based at least in part on a priority, rather than based on random-based resource selection. The UE 520 may also preempt the SR resource based at least in part on traffic metrics (e.g., remaining latency versus latency requirement) specific to each XR/CG UE.

A UE may reserve a Uu resource for SR transmission and notify other UEs, that multiplex the same resource, of the reservation (e.g., via PC5 signaling of reservation information). The priority of traffic corresponding to the SR may also be groupcast to other UEs via PC5 signaling. Other UEs may know of the reservation of the UE and not transmit an SR on the SR resource. If another UE has a higher priority than the UE, the other UE may preempt the reservation of the UE to transmit an SR. The preempted UE may then have a higher priority to transmit an SR in the next occasion.

As shown by reference number 615, the UE 610 (and other UEs) may transmit reservation information associated with SRs. The reservation information may indicate resources reserved for SR and/or for other communications. The reservation information may indicate a latency requirement, a latency status, a priority, or other traffic information.

As shown by reference number 620, the UE 520 may selectively transmit an SR based at least in part on a priority of each UE indicated in the reservation information. Selectively transmitting the SR may include transmitting the SR based at least in part on the UE 520 having a higher priority than the other UEs, or refraining from transmitting the SR based at least in part on the UE 520 having a lower priority than the other UEs.

Some SR transmissions may fail. For example, when a PC5 interface has poor channel conditions, a notification may fail to be sent to other UEs via the PC5 interface, leading to collision among UEs. In some aspects, the UE 520 may retransmit an SR based at least in part on an expiration of a resume SR timer (e.g., sr-ResumeTimer) that starts after a failure of the SR. The resume SR timer may be enhanced to complement each UE, to resolve an SR transmission failure because of contention. Each UE may trigger a specific resume SR timer when the UE transmits an SR. A UE that succeeds in transmitting an SR may proceed with a PUSCH communication on the configured uplink grant. The UE that fails to transmit an SR may attempt to transmit the SR after its resume SR timer expires. As a result, collisions and latency are reduced and signaling resources are conserved.

As indicated above, FIG. 6 is provided as an example. Other examples may differ from what is described with regard to FIG. 6.

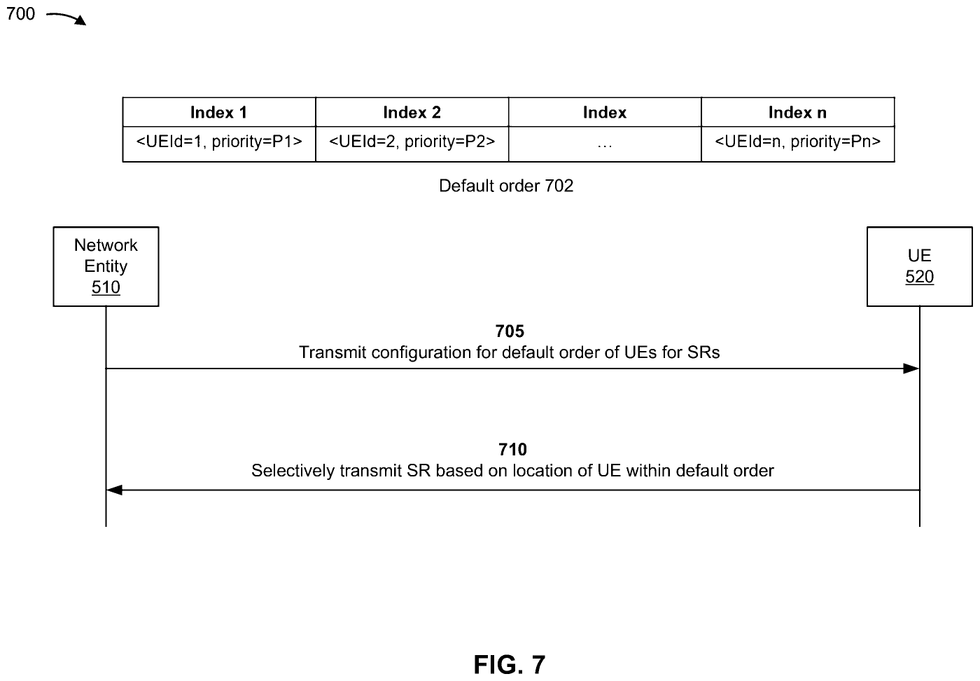

FIG. 7 is a diagram illustrating an example 700 associated with a default order for using a group common resource for SRs, in accordance with the present disclosure.

The network entity 510 may know which UEs will multiplex the same configured resource to transmit an SR. In some aspects, the network entity 510 may preconfigure a default order for the UEs that multiplex and transmit SRs in the configured resource. For example, the default order may indicate which UE is to transmit an SR first, which UE is to transmit an SR second, and so forth. The resource may be configured by high layer signaling to all UEs or to part of the UEs in a specific group. Example 700 shows a default order 702 that orders UEs by priority. As shown by reference number 705, the network entity 510 may transmit a configuration (e.g., table, PUCCH-config) for the default order 702 of UEs for transmitting SRs.

The UE 520 may use the resource to transmit an SR based at least in part on where the UE 520 fits within the default order 702. As shown by reference number 710, the UE 520 may transmit an SR based at least in part on a location of the UE 520 within the default order 702. For example, the UE 520 may transmit the SR if the UE 520 is next in the default order 702, and not transmit if the UE 520 is not next in line.

As indicated above, FIG. 7 is provided as an example. Other examples may differ from what is described with regard to FIG. 7.

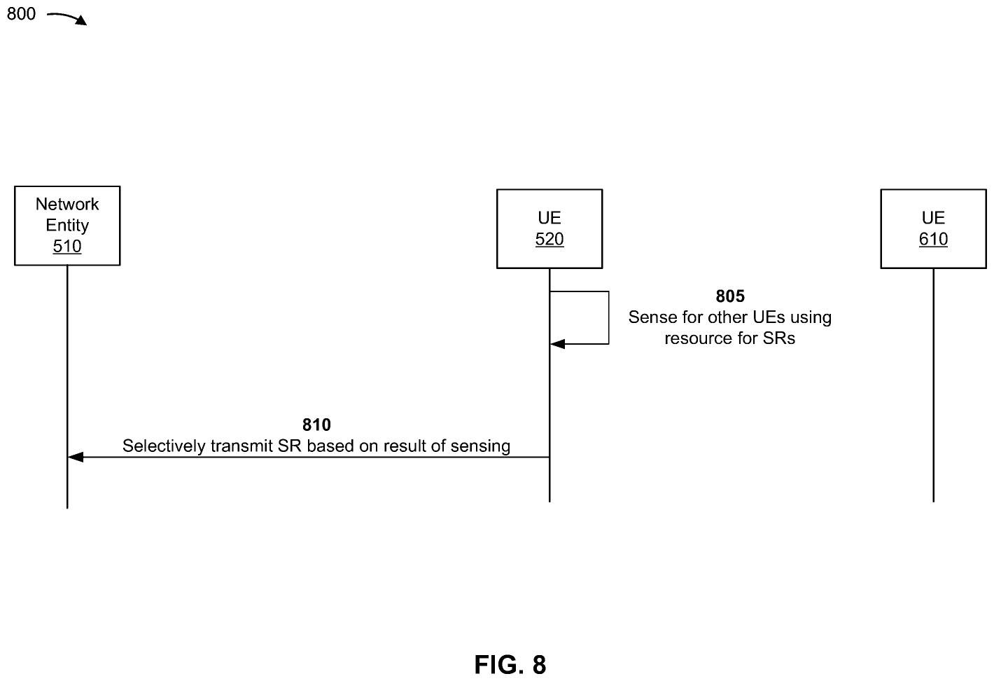

FIG. 8 is a diagram illustrating an example 800 associated with using a group common resource for SRs, in accordance with the present disclosure.

In some aspects, the UE 520 may sense for other UEs using a multiplexing resource for SRs. The network entity 510 may indicate the resource with higher layer signaling. When a traffic load arrives at a buffer of the UE 520, the UE 520 may sense the configured resource to check whether there is another UE using the resource to transmit an SR, as shown by reference number 805.

As shown by reference number 810, the UE 520 may selectively transmit an SR based at least in part on a result of the sensing. If there is no other UE using the resource to transmit an SR, the UE 520 may transmit an SR. If there is another UE using the resource to transmit an SR, the UE 520 may back off from transmitting an SR on the resource.

In some aspects, if an SR can be enhanced to implicitly carry some information about priority, the UE 520 may autonomously determine the transmission order on the configured multiplexing resource. The UE with a higher priority may preempt the resource that a UE with a lower priority has reserved. In this way, high priority traffic transmission can be guaranteed in the contention-based SR scheme.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120, UE 520) performs operations associated with using a group common resource for SRs.

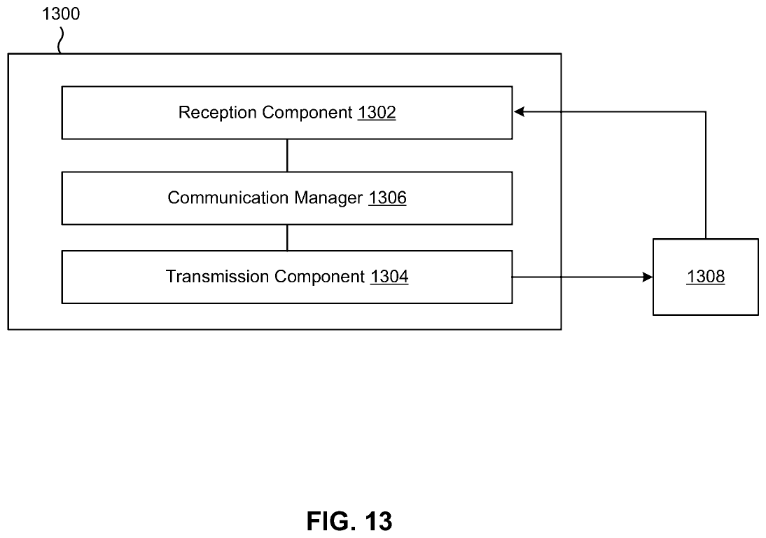

As shown in FIG. 9, in some aspects, process 900 may include receiving a grant associated with a group common SR resource (block 910). For example, the UE (e.g., using reception component 1302 and/or communication manager 1306, depicted in FIG. 13) may receive a grant associated with a group common SR resource, as described above.

As further shown in FIG. 9, in some aspects, process 900 may include transmitting an SR based at least in part on the UE belonging to a group associated with the group common SR resource (block 920). For example, the UE (e.g., using transmission component 1304 and/or communication manager 1306, depicted in FIG. 13) may transmit an SR based at least in part on the UE belonging to a group associated with the group common SR resource, as described above.

Process 900 may include additional aspects, such as any single aspect or any combination of aspects described below and/or in connection with one or more other processes described elsewhere herein.

In a first aspect, process 900 includes identifying the group common SR resource based at least in part on a group common C-RNTI.

In a second aspect, alone or in combination with the first aspect, the grant is scrambled with the C-RNTI.

In a third aspect, alone or in combination with one or more of the first and second aspects, the grant is included in a MAC CE.

In a fourth aspect, alone or in combination with one or more of the first through third aspects, process 900 includes activating the group common SR resource based at least in part on L1 or L2 signaling.

In a fifth aspect, alone or in combination with one or more of the first through fourth aspects, the L1 or L2 signaling includes a group common MAC CE.

In a sixth aspect, alone or in combination with one or more of the first through fifth aspects, the L1 or L2 signaling includes group common DCI.

In a seventh aspect, alone or in combination with one or more of the first through sixth aspects, process 900 includes activating the group common SR resource based at least in part on a WUS.

In an eighth aspect, alone or in combination with one or more of the first through seventh aspects, the WUS is scrambled with an ID associated with the group.

In a ninth aspect, alone or in combination with one or more of the first through eighth aspects, the group common SR resource associated with the group does not overlap with a group common SR resource associated with another group.

In a tenth aspect, alone or in combination with one or more of the first through ninth aspects, contention-based resource selection is limited to UEs within the group.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120, UE 520) performs operations associated with using a group common resource for SRs.

As shown in FIG. 10, in some aspects, process 1000 may include receiving reservation information, associated with SRs, from other UEs (block 1010). For example, the UE (e.g., using reception component 1302 and/or communication manager 1306, depicted in FIG. 13) may receive reservation information, associated with SRs, from other UEs, as described above.

As further shown in FIG. 10, in some aspects, process 1000 may include selectively transmitting an SR based at least in part on a priority of each UE indicated in the reservation information (block 1020). For example, the UE (e.g., using transmission component 1304 and/or communication manager 1306, depicted in FIG. 13) may selectively transmit an SR based at least in part on a priority of each UE indicated in the reservation information, as described above.

Process 1000 may include additional aspects, such as any single aspect or any combination of aspects described below and/or in connection with one or more other processes described elsewhere herein.

In a first aspect, selectively transmitting the SR includes transmitting the SR based at least in part on the UE having a higher priority than the other UEs, or refraining from transmitting the SR based at least in part on the UE having a lower priority than the other UEs.

In a second aspect, alone or in combination with the first aspect, the priority of each UE of the other UEs is associated with a latency requirement and a respective remaining latency for the UE.

In a third aspect, alone or in combination with one or more of the first and second aspects, process 1000 includes retransmitting the SR based at least in part on an expiration of a resume SR timer that starts after a failure of the SR.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120, UE 520) performs operations associated with group common resource for scheduling requests.

As shown in FIG. 11, in some aspects, process 1100 may include receiving a configuration for a default order of UEs for SRs (block 1110). For example, the UE (e.g., using reception component 1302 and/or communication manager 1306, depicted in FIG. 13) may receive a configuration for a default order of UEs for SRs, as described above.

As further shown in FIG. 11, in some aspects, process 1100 may include selectively transmitting an SR based at least in part on a location of the UE within the default order (block 1120). For example, the UE (e.g., using transmission component 1304 and/or communication manager 1306, depicted in FIG. 13) may selectively transmit an SR based at least in part on a location of the UE within the default order, as described above.

Process 1100 may include additional aspects, such as any single aspect or any combination of aspects described below and/or in connection with one or more other processes described elsewhere herein.

In a first aspect, the default order orders UEs by priority.

In a second aspect, alone or in combination with the first aspect, selectively transmitting the SR includes transmitting the SR based at least in part on the UE being next in order, according to the default order.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120, UE 520) performs operations associated with group common resource for scheduling requests.

As shown in FIG. 12, in some aspects, process 1200 may include sensing for other UEs using a multiplexing resource for SRs (block 1210). For example, the UE (e.g., using communication manager 1306, depicted in FIG. 13) may sense for other UEs using a multiplexing resource for SRs, as described above.

As further shown in FIG. 12, in some aspects, process 1200 may include selectively transmitting an SR based at least in part on a result of the sensing (block 1220). For example, the UE (e.g., using transmission component 1304 and/or communication manager 1306, depicted in FIG. 13) may selectively transmit an SR based at least in part on a result of the sensing, as described above.

Process 1200 may include additional aspects, such as any single aspect or any combination of aspects described below and/or in connection with one or more other processes described elsewhere herein.

In a first aspect, selectively transmitting the SR includes transmitting the SR based at least in part on the result indicating that another UE is using the multiplexing resource, or refraining from transmitting the SR based at least in part on the result indicating that no other UE is using the multiplexing resource.

In a second aspect, alone or in combination with the first aspect, process 1200 includes overriding a reservation of the multiplexing resource based at least in part on a priority of the UE being greater than a priority of another UE.

In a third aspect, alone or in combination with one or more of the first and second aspects, the priority of the other UE is indicated in an SR from the other UE.

In a fourth aspect, alone or in combination with one or more of the first through third aspects, sensing for other UEs includes sensing for other UEs based at least in part on a traffic load in a buffer of the UE.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UF (e.g., UF 120, UF 520), or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 1-8. Additionally, or alternatively, the apparatus 1300 may be configured to perform one or more processes described herein, such as process 900 of FIG. 9, process 1000 of FIG. 10, process 1100 of FIG. 11, process 1200 of FIG. 12, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

In some aspects, the reception component 1302 may receive a grant associated with a group common SR resource. The transmission component 1304 may transmit an SR based at least in part on the UE belonging to a group associated with the group common SR resource.

The communication manager 1306 may identify the group common SR resource based at least in part on a group common C-RNTI. The communication manager 1306 may activate the group common SR resource based at least in part on L1 or L2 signaling. The communication manager 1306 may activate the group common SR resource based at least in part on a WUS.

In some aspects, the reception component 1302 may receive reservation information, associated with SRs, from other UEs. The transmission component 1304 may selectively transmit an SR based at least in part on a priority of each UE indicated in the reservation information. The transmission component 1304 may retransmit the SR based at least in part on an expiration of a resume SR timer that starts after a failure of the SR.

In some aspects, the reception component 1302 may receive a configuration for a default order of UEs for SRs. The transmission component 1304 may selectively transmit an SR based at least in part on a location of the UE within the default order.

In some aspects, the communication manager 1306 may sense for other UEs using a multiplexing resource for SRs. The transmission component 1304 may selectively transmit an SR based at least in part on a result of the sensing. The communication manager 1306 may override a reservation of the multiplexing resource based at least in part on a priority of the UE being greater than a priority of another UE.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

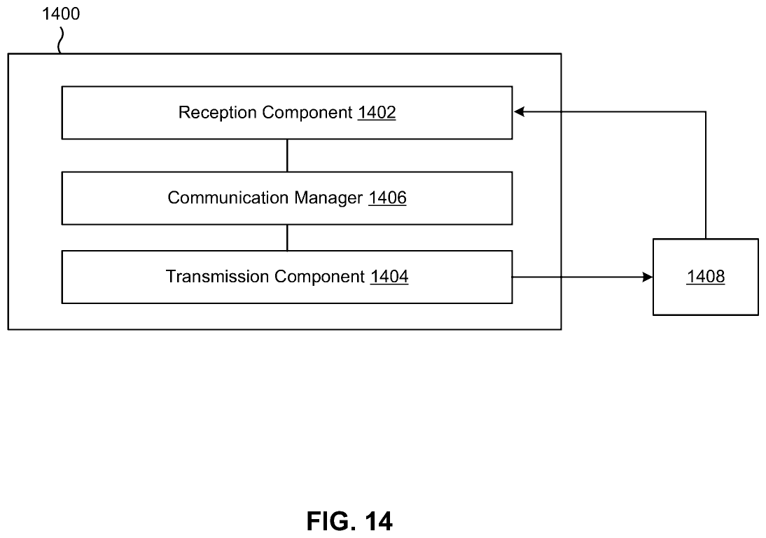

FIG. 14 is a diagram of an example apparatus 1400 for wireless communication, in accordance with the present disclosure. The apparatus 1400 may be a network entity (e.g., network node 110, network entity 510), or a network entity may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 1-8. Additionally, or alternatively, the apparatus 1400 may be configured to perform one or more processes described herein. In some aspects, the apparatus 1400 and/or one or more components shown in FIG. 14 may include one or more components of the network entity described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network entity described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the network entity described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

In some aspects, the transmission component 1404 may transmit a grant associated with a group common SR resource. The reception component 1402 may receive an SR based at least in part on a UE belonging to a group associated with the group common SR resource.

The transmission component 1404 may activate the group common SR resource based at least in part on L1 or L2 signaling. The transmission component 1404 may activate the group common SR resource based at least in part on a WUS.

In some aspects, the transmission component 1404 may transmit a configuration for a default order of UEs for SRs. The reception component 1402 may receive an SR based at least in part on a location of a UE within the default order.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by a user equipment (UE), comprising: receiving a grant associated with a group common scheduling request (SR) resource; and transmitting an SR based at least in part on the UE belonging to a group associated with the group common SR resource.
Aspect 2: The method of Aspect 1, further comprising identifying the group common SR resource based at least in part on a group common cell-specific radio network temporary identifier (C-RNTI).
Aspect 3: The method of Aspect 2, wherein the grant is scrambled with the C-RNTI.
Aspect 4: The method of Aspect 2 or 3, wherein the grant is included in a medium access control control element (MAC CE).
Aspect 5: The method of any of Aspects 1-4, further comprising activating the group common SR resource based at least in part on Layer 1 (L1) or Layer 2 (L2) signaling.
Aspect 6: The method of Aspect 5, wherein the L1 or L2 signaling includes a group common medium access control control element (MAC CE).
Aspect 7: The method of Aspect 5, wherein the L1 or L2 signaling includes group common downlink control information.
Aspect 8: The method of any of Aspects 1-7, further comprising activating the group common SR resource based at least in part on a wake-up signal (WUS).
Aspect 9: The method of Aspect 8, wherein the WUS is scrambled with an identifier associated with the group.
Aspect 10: The method of any of Aspects 1-9, wherein the group common SR resource associated with the group does not overlap with a group common SR resource associated with another group.
Aspect 11: The method of any of Aspects 1-10, wherein contention-based resource selection is limited to UEs within the group.
Aspect 12: A method of wireless communication performed by a user equipment (UE), comprising: receiving reservation information, associated with scheduling requests (SRs), from other UEs; and selectively transmitting an SR based at least in part on a priority of each UE indicated in the reservation information.
Aspect 13: The method of Aspect 12, wherein selectively transmitting the SR includes: transmitting the SR based at least in part on the UE having a higher priority than the other UEs, or refraining from transmitting the SR based at least in part on the UE having a lower priority than the other UEs.
Aspect 14: The method of any of Aspects 12-13, wherein the priority of each UE of the other UEs is associated with a latency requirement and a respective remaining latency for the UE.
Aspect 15: The method of any of Aspects 12-14, further comprising retransmitting the SR based at least in part on an expiration of a resume SR timer that starts after a failure of the SR.
Aspect 16: A method of wireless communication performed by a user equipment (UE), comprising: receiving a configuration for a default order of UEs for scheduling requests (SRs); and selectively transmitting an SR based at least in part on a location of the UE within the default order.
Aspect 17: The method of Aspect 16, wherein the default order orders UEs by priority.
Aspect 18: The method of any of Aspects 16-17, wherein selectively transmitting the SR includes transmitting the SR based at least in part on the UE being next in order, according to the default order.
Aspect 19: A method of wireless communication performed by a user equipment (UE), comprising: sensing for other UEs using a multiplexing resource for scheduling requests (SRs); and selectively transmitting an SR based at least in part on a result of the sensing.
Aspect 20: The method of Aspect 19, wherein selectively transmitting the SR includes: transmitting the SR based at least in part on the result indicating that another UE is using the multiplexing resource, or refraining from transmitting the SR based at least in part on the result indicating that no other UE is using the multiplexing resource.
Aspect 21: The method of Aspect 20, further comprising overriding a reservation of the multiplexing resource based at least in part on a priority of the UE being greater than a priority of another UE.
Aspect 22: The method of any of Aspects 19-21, wherein the priority of the other UE is indicated in an SR from the other UE.
Aspect 23: The method of any of Aspects 19-22, wherein sensing for other UEs includes sensing for other UEs based at least in part on a traffic load in a buffer of the UE.
Aspect 24: An apparatus for wireless communication at a device, comprising a processor; memory coupled with the processor; and instructions stored in the memory and executable by the processor to cause the apparatus to perform the method of one or more of Aspects 1-23.
Aspect 25: A device for wireless communication, comprising a memory and one or more processors coupled to the memory, the one or more processors configured to perform the method of one or more of Aspects 1-23.
Aspect 26: An apparatus for wireless communication, comprising at least one means for performing the method of one or more of Aspects 1-23.
Aspect 27: A non-transitory computer-readable medium storing code for wireless communication, the code comprising instructions executable by a processor to perform the method of one or more of Aspects 1-23.
Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive a grant associated with a group common scheduling request (SR) resource; and
transmit an SR based at least in part on the UE belonging to a group associated with the group common SR resource.

2. The UE of claim 1, wherein the one or more processors are configured to identify the group common SR resource based at least in part on a group common cell-specific radio network temporary identifier (C-RNTI).

3. The UE of claim 2, wherein the grant is scrambled with the C-RNTI.

4. The UE of claim 2, wherein the grant is included in a medium access control control element (MAC CE).

5. The UE of claim 1, wherein the one or more processors are configured to activate the group common SR resource based at least in part on Layer 1 (L1) or Layer 2 (L2) signaling.

6. The UE of claim 5, wherein the L1 or L2 signaling includes a group common medium access control control element (MAC CE).

7. The UE of claim 5, wherein the L1 or L2 signaling includes group common downlink control information.

8. The UE of claim 1, wherein the one or more processors are configured to activate the group common SR resource based at least in part on a wake-up signal (WUS).

9. The UE of claim 8, wherein the WUS is scrambled with an identifier associated with the group.

10. The UE of claim 1, wherein the group common SR resource associated with the group does not overlap with a group common SR resource associated with another group.

11. The UE of claim 1, wherein contention-based resource selection is limited to UEs within the group.

12. A user equipment (UE) for wireless communication, comprising:
a memory; and
one or more processors, coupled to the memory, configured to:
receive reservation information, associated with scheduling requests (SRs), from other UEs; and
selectively transmit an SR based at least in part on a priority of each UE indicated in the reservation information.

13. The UE of claim 12, wherein the one or more processors, to selectively transmit the SR, are configured to:
transmit the SR based at least in part on the UE having a higher priority than the other UEs, or
refrain from transmitting the SR based at least in part on the UE having a lower priority than the other UEs.

14. The UE of claim 12, wherein the priority of each UE of the other UEs is associated with a latency requirement and a respective remaining latency for the UE.

15. The UE of claim 12, wherein the one or more processors are configured to retransmit the SR based at least in part on an expiration of a resume SR timer that starts after a failure of the SR.

16. A user equipment (UE) for wireless communication, comprising:
a memory; and
one or more processors, coupled to the memory, configured to:
receive a configuration for a default order of UEs for scheduling requests (SRs); and
selectively transmit an SR based at least in part on a location of the UE within the default order.

17. The UE of claim 16, wherein the default order orders UEs by priority.

18. The UE of claim 16, wherein the one or more processors, to selectively transmit the SR, are configured to transmit the SR based at least in part on the UE being next in order, according to the default order.

19. A user equipment (UE) for wireless communication, comprising:
a memory; and
one or more processors, coupled to the memory, configured to:
sense for other UEs using a multiplexing resource for scheduling requests (SRs); and
selectively transmit an SR based at least in part on a result of the sensing.

20. The UE of claim 19, wherein the one or more processors, to selectively transmit the SR, are configured to:
transmit the SR based at least in part on the result indicating that another UE is using the multiplexing resource, or
refrain from transmitting the SR based at least in part on the result indicating that no other UE is using the multiplexing resource.

21-23. (canceled)
